(19) United States
(12) Patent Application Publication
(10) Pub. No.: US 2023/0281689 A1
(43) Pub. Date: Sep. 7, 2023

(54) CONTROL METHOD, RECORDING MEDIUM, AND TERMINAL

(71) Applicant: Panasonic Intellectual Property Corporation of America, Torrance, CA (US)

(72) Inventors: Ayaka MITANI, Osaka (JP); Naohisa NISHIDA, Osaka (JP); Kakuya YAMAMOTO, Hyogo (JP); Junichiro SOEDA, Nara (JP); Junji MICHIYAMA, Fukuoka (JP)

(21) Appl. No.: 18/197,233

(22) Filed: May 15, 2023

Related U.S. Application Data
(63) Continuation-in-part of application No. PCT/JP2021/041334, filed on Nov. 10, 2021.
(60) Provisional application No. 63/115,184, filed on Nov. 18, 2020.

(51) Int. Cl. G06Q 30/0601; G06K 7/10; G06Q 20/06

(52) U.S. Cl. CPC G06Q 30/0623; G06K 7/10366; G06Q 20/0655

(57) ABSTRACT

A control method according to the present disclosure is a method for controlling a first terminal carried by a first user and capable of communicating with a server via a network and includes: establishing short-range wireless communication by the first terminal with a second terminal carried by a second user; requesting the second terminal by the first terminal via the short-range wireless communication to provide item information, which is information related to at least one item included in one or more items worn by the second user, or requesting the server by the first terminal via the network to provide the item information, using identification information of at least one item that has been obtained upon the establishment of the short-range wireless communication; obtaining the item information by the first terminal; and transmitting, to the server, item positive-obtainment information indicating that the item information has been obtained.

### CROSS REFERENCE TO RELATED APPLICATIONS

This is a continuation application of PCT International Application No. PCT/JP2021/041334 filed on Nov. 10, 2021, designating the United States of America, which is based on and claims priority of U.S. Provisional Pat. Application No. 63/115184 filed on Nov. 18, 2020. The entire disclosures of the above-identified applications, including the specifications, drawings and claims are incorporated herein by reference in their entirety.

### FIELD

The present disclosure relates to methods for controlling terminals carried by users, recording media, and the terminals.

### BACKGROUND

Affiliate marketing is known in which when users who clicked an advertisement link suggested by an affiliate make transactions such as a purchase of a product or a service on an advertiser’s website, an advertiser pays the affiliate (for example, refer to Patent Literature (PTL) 1).

### CITATION LIST

### Patent Literature

PTL 1: Japanese Unexamined Patent Application Publication No. 2018-025862

### SUMMARY

### Technical Problem

However, in the system disclosed in PTL 1, an affiliate needs to suggest a product using a network website such as SNS, meaning that a merchandise item such as clothing actually worn by the affiliate cannot be physically suggested to a user who is passing the affiliate.

In other words, a problem with the system disclosed in PTL 1 is that an affiliate cannot advertise an item such as clothing actually worn by him or herself to a user who is passing him or herself. As a result, it is also problematic that the affiliate is unable to encourage people to take an action that may lead to closing of a transaction of said item.

The present disclosure is conceived in view of the above-described circumstances and has an object to provide a control method, a recording medium, and a terminal that enable physical item advertising using passer-by communication.

### Solution to Problem

In order to achieve the aforementioned object, a control method according to the present disclosure is a method for controlling a first terminal carried by a first user and capable of communicating with a server via a network and includes: establishing short-range wireless communication by the first terminal with a second terminal carried by a second user; requesting the second terminal by the first terminal via the short-range wireless communication to provide item information, or requesting the server by the first terminal via the network to provide the item information, the item information being information related to at least one item included in one or more items worn by the second user, the requesting being performed using identification information of the at least one item that has been obtained upon the establishment of the short-range wireless communication; obtaining the item information by the first terminal; and transmitting, to the server, item positive-obtainment information indicating that the item information has been obtained.

Note that these general and specific aspects may be implemented using a system, an integrated circuit, a computer program, or a computer-readable recording medium such as compact disc read-only memory (CD-ROM), or any combination of systems, methods, integrated circuits, computer programs, or recording media.

### Advantageous Effects

With the control method, etc., according to the present disclosure, physical item advertising is possible using passer-by communication.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 FIG. 1 is a diagram schematically showing passer-by communication between terminals according to Embodiment 1.

FIG. 2 FIG. 2 is a diagram schematically showing the overall configuration of a control system according to Embodiment 1.

FIG. 3 FIG. 3 is a block diagram showing one example of the configuration of a terminal according to Embodiment 1.

FIG. 4 FIG. 4 is a flowchart showing the outline of an operation of a terminal according to Embodiment 1.

FIG. 5 FIG. 5 is a first sequence chart showing processes of a control system according to Embodiment 1.

FIG. 6 FIG. 6 is a second sequence chart showing processes of a control system according to Embodiment 1.

FIG. 7 FIG. 7 is a third sequence chart showing processes of a control system according to Embodiment 1.

FIG. 8FIG. 8 is a fourth sequence chart showing processes of a control system according to Embodiment 1.

FIG. 9 FIG. 9 is a fifth sequence chart showing processes of a control system according to Embodiment 1.

[FIG. 10FIG. 10 is a sequence chart showing processes of a control system according to a variation of Embodiment 1.

FIG. 11 FIG. 11 is a diagram schematically showing an overview of a use case according to Embodiment 1.

FIG. 12 FIG. 12 is a diagram showing one example of a BLE connection selecting user interface (UI) according to a comparative example.

FIG. 13 FIG. 13 is a diagram showing one example of a short-range wireless communication connection selecting UI according to Embodiment 2.

FIG. 14 FIG. 14 is a flowchart showing one example of an operation of a terminal according to Embodiment 2.

FIG. 15FIG. 15 is a flowchart showing another example of an operation of a terminal according to Embodiment 2.

FIG. 16 FIG. 16 is a flowchart showing a detailed operation of Step S35 shown in FIG. 15.

### DESCRIPTION OF EMBODIMENTS

A control method according to one aspect of the present disclosure is a method for controlling a first terminal carried by a first user and capable of communicating with a server via a network and includes: establishing short-range wireless communication by the first terminal with a second terminal carried by a second user; requesting the second terminal by the first terminal via the short-range wireless communication to provide item information, or requesting the server by the first terminal via the network to provide the item information, the item information being information related to at least one item included in one or more items worn by the second user, the requesting being performed using identification information of the at least one item that has been obtained upon the establishment of the short-range wireless communication; obtaining the item information by the first terminal; and transmitting, to the server, item positive-obtainment information indicating that the item information has been obtained.

In this manner, using the first terminal that has established the short-range wireless communication with the second terminal of the second user via the passer-by communication, the first user obtains the item information of at least one item among the physical items worn by the second user, and transmits the item positive-obtainment information to the server. In other words, the second user can advertise, to the first user, an item actually worn by him or herself and can encourage the first user to obtain the item information, which is one action that may lead to closing of a transaction of said item.

In this manner, physical item advertising is possible using the passer-by communication.

Here, for example, the obtaining of the item information may include: obtaining the item information by the first terminal from the second terminal or the server.

Furthermore, for example, when the short-range wireless communication is established with the second terminal, the first terminal may obtain the identification information of the at least one item from a radio-frequency identification (RFID) tag attached to the at least one item.

Furthermore, for example, the establishing may include: receiving a communication signal including identification information of the one or more items and information indicating a location of product information of the one or more items, the communication signal being predetermined and transmitted from a RFID tag attached to the one or more items; obtaining a surrounding image of the first terminal from a camera included in the first terminal, the surrounding image including the second user; establishing the short-range wireless communication with the second terminal when the one or more items are included in the surrounding image; and displaying, by the first terminal, the surrounding image on a display included in the first terminal, with the product information of the one or more items being superimposed onto the surrounding image, the product information being obtained based on the information indicating the location.

This allows the first user to not only establish the short-range wireless communication more easily via the passer-by communication, but also select, by referring to an image and the like showing the product information, at least one of the physical items worn by the second user.

Furthermore, for example, the receiving may include: obtaining radio signal strength of an RFID tag attached to each of the one or more items, the obtaining of the surrounding image may include: obtaining distance information indicating a distance from the first terminal to each of the one or more items included in the surrounding image, and in the displaying, when a difference between a first distance, which is indicated by the radio signal strength and is a distance between the first terminal and the RFID tag attached to one item included in the one or more items, and a second distance, which is indicated in the distance information that corresponds to the one item, is not within a predetermined range, the surrounding image may be displayed without the product information being superimposed onto the surrounding image.

This makes it possible to reduce malfunctions including a failure to obtain the item information of at least one item selected by the first user due to a failure to properly obtain the item identifier of said item.

Furthermore, for example, a coupon that is usable in an online store where an item indicated in the item positive-obtainment information is available for purchase may further be obtained from the server.

In this manner, the first user who carries the first terminal can obtain a coupon that is usable in an online store where the item can be purchased; therefore, it is possible to encourage the first user to take an action to purchase the item.

Furthermore, for example, when the item positive-obtainment information is transmitted to the server, a coin issued by a seller of an item indicated in the item positive-obtainment information is transmitted to the second terminal.

In this manner, when the first user is successfully encouraged to take an action leading to the purchase of the item such as the obtainment of the item information, the second user can obtain, as a reward, a coin issued by the seller of the item, for example. Such an incentive can motivate the second user to engage in physical item advertising in which the passer-by communication is used.

Furthermore, for example, the coin may be issued when the item positive-obtainment information is recorded in the server.

Furthermore, for example, the server may be included in a blockchain, and the server may issue the coin after the item positive-obtainment information is recorded in the blockchain.

Furthermore, for example, the server may be included in a blockchain, and when the short-range wireless communication is established with the second terminal, the first terminal may obtain a one-time password and identification information of each of the one or more items from the second terminal via the short-range wireless communication. The requesting the server to provide the item information may include: generating, by the first terminal, transaction data including the one-time password and the identification information of the at least one item; and transmitting the transaction data from the first terminal to the server to cause the transaction data to be recorded in the blockchain. The obtaining of the item information may include: when a password recorded in the blockchain and the one-time password match each other, obtaining, by the first terminal, the item information transmitted from the server.

With this, it can be ensured that when the identification information of the item is obtained using a means other than the passer-by communication, the item information will not be obtained.

Furthermore, for example, the server may be included in a blockchain, and when the short-range wireless communication is established with the second terminal, the first terminal may obtain a public key and identification information of each of the one or more items from the second terminal via the short-range wireless communication. The requesting the server to provide the item information may include: generating, by the first terminal, transaction data including the public key and the identification information of the at least one item; and transmitting the transaction data from the first terminal to the server to cause the transaction data to be recorded in the blockchain. The obtaining of the item information may include: when a public key recorded in the blockchain and a private key held by the second terminal match each other, obtaining, by the first terminal, the item information transmitted from the server.

With this, it can be ensured that when the identification information of the item is obtained using a means other than the passer-by communication, the item information will not be obtained.

A terminal according to one aspect of the present disclosure is carried by a first user and capable of communicating with a server via a network and includes: a processor; and memory. Using the memory, the processor executes: establishing short-range wireless communication with a terminal carried by a second user; requesting the terminal carried by the second user via the short-range wireless communication to provide item information, or requesting the server via the network to provide the item information, the item information being information related to at least one item included in one or more items worn by the second user, the requesting being performed using identification information of the at least one item that has been obtained upon the establishment of the short-range wireless communication; obtaining the item information; and transmitting, to the server, item positive-obtainment information indicating that the item information has been obtained.

Hereinafter, exemplary embodiments of the present disclosure will be described in detail with reference to the drawings. Note that each of the exemplary embodiment described below shows a specific preferred example of the present disclosure. This means that the numerical values, shapes, materials, structural elements, the arrangement and connection of the structural elements, steps, the processing order of the steps, etc., shown in the following exemplary embodiments are mere examples, and are not intended to limit the present disclosure. The present disclosure is defined based on the recitations of the Claims. Therefore, among the structural elements in the following exemplary embodiments, structural elements not recited in any one of the independent claims which indicate the broadest concepts of the present disclosure are not necessarily required to achieve the object of the present disclosure, but are described as structural elements of a more preferred exemplary embodiment.

### Embodiment 1

### 1 Passer-by Communication

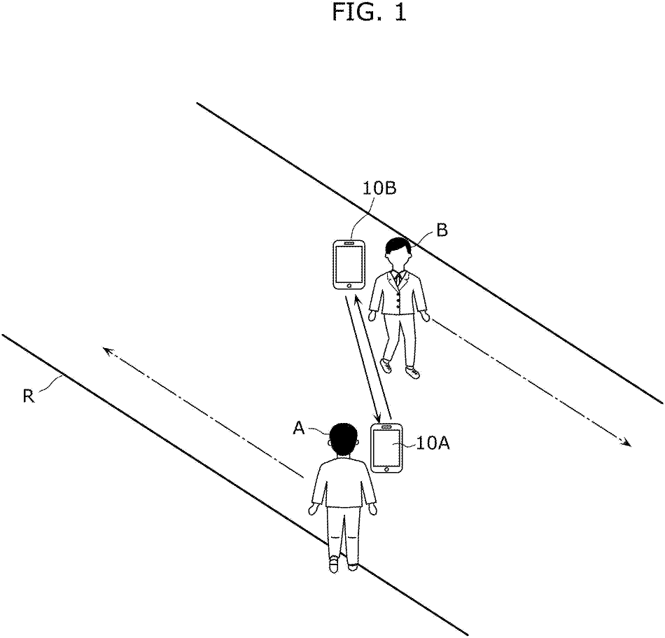

FIG. 1 is a diagram schematically showing passer-by communication between terminals according to Embodiment 1.

The following describes the case where user B has an intention to advertise an item worn by him or herself and user A is interested in the physical item advertised by user B.

Carrying terminal 10A, user A is moving. Carrying terminal 10B, user B is moving.

Assume that during movement of user A and user B on road R, for example, when terminal 10A and terminal 10B are located at a distance at which short-range wireless communication is available, terminal 10A and terminal 10B establish the short-range wireless communication to transmit and receive information about an item worn by user B. The short-range wireless communication between terminals moving together with users is referred to as passer-by communication. Note that this can also apply when each item worn by user B is provided with an active radio-frequency identification (RFID) tag. Specifically, during movement of user A and user B on road R, for example, when terminal 10A comes close enough to perform the short-range wireless communication with the active RFID tag, terminal 10A may receive information of the item from the active RFID tag. The communication performed in this case will also be referred to as passer-by communication in the present exemplary embodiment; a detailed description will follow.

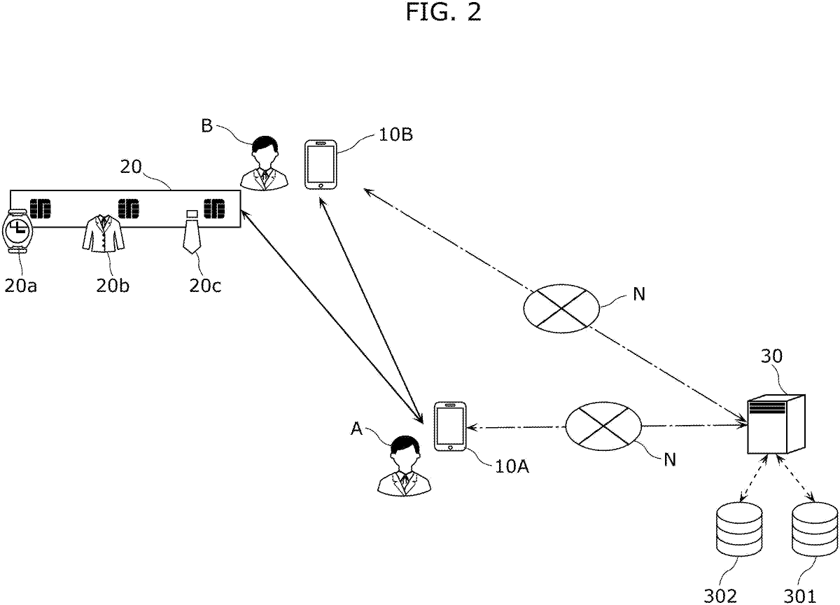

Thus, identification information of the item worn by user B, such as an item identifier, is provided to terminal 10A of user A. Note that the identification information of the item worn by user B may be provided from item tag 20 attached to, for example, items such as watch 20a, jacket 20b, and tie 20c worn by user B, as illustrated in FIG. 2. Subsequently, user A can obtain, on the basis of the provided identification information of the item, item information which is related to the item that user A is interested in. In the present exemplary embodiment, the item information may be a uniform resource locator (URL) from which online information about the item is accessible, an image or video of the item corresponding to the item identifier, a quick response (QR) code generated on the basis of the URL, an illustration or an icon that has been output by a generative artificial intelligence (AI) on the basis of the item information, or a text-to-speech voice for visually impaired individuals, for example.

In this manner, user B advertises the item actually worn by him or herself to user A and thus can encourage user A to obtain the item information, which is one action that may lead to closing of a transaction of said item.

Next, a system configuration according to the present disclosure will be described.

### 2 System Configuration

### 2.1 Overall Configuration of Control System

FIG. 2 is a diagram schematically showing the overall configuration of a control system according to Embodiment 1.

The control system according to an exemplary embodiment includes terminal 10A, terminal 10B, item tag 20, and service server 30, as shown in FIG. 2. Each of terminal 10A and terminal 10B and service server 30 can be connected via network N. Network N may be any communication line or any network and may include the Internet, a cell-phone carrier network, an access network provided by an Internet provider, and a public access network, for example. Service server 30 is not limited to one service server illustrated in FIG. 2 and may be two or more service servers.

Hereinafter, the user of terminal 10A will be referred to as user A, and the user of terminal 10B will be referred to as user B.

Note that terminal 10A, terminal 10B, and one or more service servers 30 may be connected to a storage device including a distributed ledger in which transaction data and blocks in the blockchain are electronically recorded. In this case, each of terminal 10A, terminal 10B, and one or more service servers 30 may be connected to the storage device via network N or may include the storage device therein as storage. In this manner, terminal 10A, terminal 10B, and one or more service servers 30 may be included in a blockchain network.

### 2.2 Configuration of Terminal 10

Terminal 10A and terminal 10B operate independently. In the present exemplary embodiment, terminal 10A and terminal 10B are described as having the same functions, but this is not limiting. Terminal 10A and terminal 10B may have different functions.

Terminal 10A is carried by a first user and is capable of communicating with a server via a network. In the example shown in FIG. 1 and FIG. 2, terminal 10A is a mobile device carried by user A and capable of communicating with service server 30 via network N.

Terminal 10B is carried by a second user. In the example shown in FIG. 1 and FIG. 2, terminal 10B is a mobile device carried by user B and capable of communicating with service server 30 via network N.

Hereinafter, terminal 10A and terminal 10B having the same functions will be collectively referred to as terminal 10.

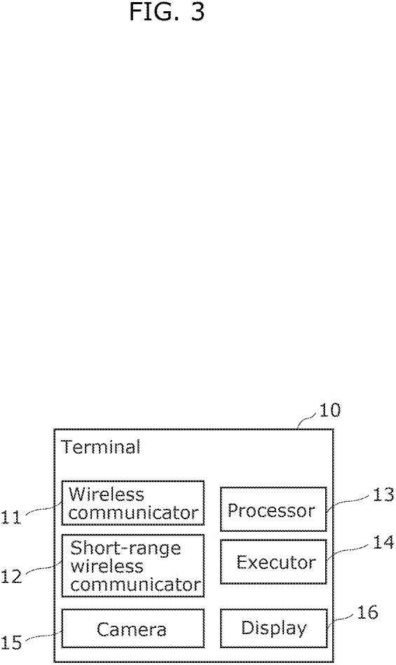

FIG. 3 is a block diagram showing one example of the configuration of terminal 10 according to Embodiment 1.

Terminal 10 includes wireless communicator 11, short-range wireless communicator 12, processor 13, executor 14, camera 15, and display 16, as shown in FIG. 3. Note that when terminal 10 is not included in a blockchain network, terminal 10 does not need to include executor 14.

### Wireless Communicator 11

Wireless communicator 11 is a wireless communication interface that is connected to network N so as to allow communication therebetween. Wireless communicator 11 may include a communication connector or a communication antenna and a communication circuit that transmit and receive communication signals in compliance with a communication standard that is appropriate for connection to network N.

In the present exemplary embodiment, wireless communicator 11 can be connected to service server 30 via network N.

### Short-Range Wireless Communicator 12

When terminal 10 is the first terminal carried by the first user, short-range wireless communicator 12 establishes short-range wireless communication with the second terminal carried by the second user. Short-range wireless communicator 12 is a communication interface that establishes wireless communication with another terminal 10 located relatively physically close thereto and transmits and receives communication signals to and from the other terminal. Examples of the communication standard for wireless communication used by short-range wireless communicator 12 include, but is not limited to, Bluetooth (registered trademark), Wi-Fi (registered trademark), or the infrared data association (IrDA) (registered trademark).

In the present exemplary embodiment, short-range wireless communicator 12 repeatedly broadcasts predetermined communication signals in compliance with the communication standard such as beacon signals, for example.

Therefore, when the distance between terminal 10 and another terminal 10 reaches a distance at which the short-range wireless communication is available, short-range wireless communicator 12 receives the predetermined communication signals from another terminal 10, senses that the short-range wireless communication between terminals 10 is available, and establishes short-range wireless communication between terminals 10. In this manner, when terminal 10 and another terminal 10 are located at a distance at which the short-range wireless communication is available, terminal 10 and another terminal 10 sense that the short-range wireless communication is available, and terminal 10 and another terminal 10 perform the short-range wireless communication.

Note that when terminal 10 is the first terminal carried by the first user, short-range wireless communicator 12 may establish short-range wireless communication with item tag 20.

### Processor 13

Processor 13 is a function part that performs processes of transmitting or receiving the identification information of an item and requesting service server 30 via the network to provide the item information, for example. Processor 13 can be implemented by a processor included in terminal 10, such as a central processing unit (CPU), for example, executing a program using memory.

For example, when terminal 10 is terminal 10A, upon establishment of the short-range wireless communication by short-range wireless communicator 12 with terminal 10B, processor 13 obtains, from terminal 10B, the identification information of each item worn by user B. Note that in establishing of the short-range wireless communication by short-range wireless communicator 12 with terminal 10B, processor 13 may obtain, from an RFID tag attached to each item worn by user B, the identification information of the item worn by user B.

Furthermore, for example, using the identification information of at least one of the one or more items worn by the second user that has been obtained upon the establishment of the short-range wireless communication, processor 13 may request one or more service servers 30 via network N to provide the item information of said item. Thus, processor 13 can obtain the item information from service server 30.

Subsequently, in this case, processor 13 may transmit, to service server 30, item positive-obtainment information indicating that the item information has been obtained. This allows processor 13 to obtain, from service server 30, a coupon that is usable in an online store where the item indicated in the item positive-obtainment information can be purchased.

Note that when terminal 10A, terminal 10B, and one or more service servers 30 are included in a blockchain network, processor 13 performs a process related to transaction data and a process related to a smart contract.

For example, at the time of storing the transaction data into the blockchain, processor 13 stores said transaction data into the blockchain using a method corresponding to the type of the blockchain. More specifically, at the time of storing the transaction data into the blockchain, processor 13 generates a block including the transaction data, and executes, on the generated block, a consensus algorithm with another terminal 10 and one or more service server 30. When an agreement is reached as a result of the execution of the consensus algorithm, processor 13 stores said block into the blockchain.

Furthermore, for example, when terminal 10 is terminal 10B, processor 13 may generate a contract code of an item management contract which is a smart contract for managing the identification information and the item information of each of the one or more items worn by the second user. In this case, processor 13 stores the generated contract code into the blockchain. This item management contract is carried out when the transaction data including at least one piece of identification information is stored into the blockchain as a result of the consensus algorithm.

Note that in the present exemplary embodiment, when the item management contract is carried out once, the item management contract is invalidated, and processor 13 generates a new item management contract every time the item management contract is invalidated. This is to avoid presenting the item information corresponding to the identification information of each of the one or more items obtained without the passer-by communication. More specifically, this is to avoid presenting the item information corresponding to the identification information of each of the one or more items when the identification information of each of the one or more items is obtained using a means other than the passer-by communication. Furthermore, this is to avoid paying a reward such as a coin issued after providing the item information.

### Executor 14

Executor 14 is a function part that carries out the smart contract. Executor 14 can be implemented by a processor included in terminal 10 executing a program using memory. Note that executor 14 may be provided only in terminal 10B.

When the transaction data indicating a smart contract execution instruction is stored into the blockchain, executor 14 carries out a corresponding smart contract.

In the present exemplary embodiment, for example, when the transaction data including the identification information such as the item identifier, a contract address, an address of terminal 10A, and, for example, a one-time password, is stored into the blockchain, executor 14 carries out the item management contract. When the one-time password matches, the item management contract transmits, to the address of terminal 10A, the item information corresponding to the identification information.

Here, the one-time password is merely one example and may be a public key. When the public key is used, it is sufficient that the item management contract be encrypted with a private key corresponding to the public key and be stored into the blockchain. For example, when the transaction data including the identification information such as the item identifier, the contract address, the address of terminal 10A, and the public key is stored into the blockchain and the item management contract is successfully decrypted with the public key, executor 14 carries out the item management contract. In this manner, when there is a match between the public key recorded in the blockchain and the private key held by terminal 10B, the item management contract is carried out, and the item information corresponding to the identification information is transmitted to the address of terminal 10A.

Note that this blockchain is merely one example of the distributed ledger and may be a distributed ledger in another form such as IOTA or hashgraph, for example, The distributed ledger may either be of a type in which the consensus algorithm is executed to store new data or of a type in which the consensus algorithm is not executed to store new data. Examples of the distributed ledger technology in which the consensus algorithm is executed include practical Byzantine fault tolerance (PBFT), proof of work (PoW), and proof of stake (PoS). One example of distributed ledger technology in which the consensus algorithm is not executed is hyperledger fabric.

### Camera 15

Camera 15, which includes a charge-coupled device (CCD) image sensor, a complementary metal-oxide-semiconductor (CMOS) image sensor, or the like, obtains an image of the surroundings of terminal 10 when operated by a user of terminal 10.

### Display 16

Display 16 interactively displays text data and the like that are input, for example, according to an operation performed by a user of terminal 10A. Display 16 may display the image obtained by camera 15.

In the present exemplary embodiment, display 16 displays permission information indicating whether short-range wireless communicator 12 is allowed to establish the short-range wireless communication, displays the item corresponding to the item identifier, and displays the item information obtained via wireless communicator 11, for example.

### 2.3 Item Tag 20

Item tag 20, which is an RFID tag attached to an item worn by user B, for example, is an active tag. In the present exemplary embodiment, item tag 20 is an RFID tag attached to each of the items worn by user B, for example, watch 20a, jacket 20b, and tie 20c, as illustrated in FIG. 2. Item tag 20 repeatedly transmits, by broadcasting, communication signals such as beacon signals including the identification information of the item. Here, the identification information of the item is the item identifier of one of the items such as watch 20a, jacket 20b, and tie 20c, for example.

### 2.4 Service Server 30

Service server 30 is a server that manages online websites that sell one or more items worn by user B. Service server 30 includes DB 301 and DB 302, as illustrated in FIG. 2. DB 301 is a database for managing images of one or more items worn by user B, for example, In the present exemplary embodiment, DB 301 manages the identification information and the item information of one or more items worn by user B, together with the images of the one or more items, for example. DB 302 is a database for managing inventory data of one or more items worn by user B that are sellable as merchandise. Service server 30 can be implemented by a processor executing a predetermined program using memory.

Service server 30 is requested by terminal 10 to provide the item information of at least one of the one or more items worn by user B that corresponds to the identification information of said item. Then, service server 30 obtains, from DB 301, the item information corresponding to the identification information of said item, and transmits the item information to terminal 10.

Furthermore, service server 30 issues a coupon to terminal 104A that has obtained the item information of one or more items worn by user B. More specifically, when service server 30 obtains, from terminal 10A, the item positive-obtainment information indicating that the item information has been obtained, service server 30 issues a coupon to terminal 10A.

Furthermore, when the item information of one or more items worn by user B is obtained, service server 30 may transmit, to terminal 10B of user B, a coin issued by a seller of said items.

Service server 30 may issue and transmit a coin when the item positive-obtainment information is recorded. The coin is one example of the token that is issued to terminal 10B of user B; the reward for user B does not need to be the coin. Note that when service server 30 is included in the blockchain, service server 30 may issue a coin after the item positive-obtainment information is recorded into the blockchain. In this case, the coin may be issued by carrying out a reward smart contract for performing the process of paying a reward or a fee. More specifically, service server 30 first generates a contract code of a reward smart contract for performing the process of paying a reward or a fee and stores the generated contract code into the blockchain. Thus, when transaction data indicating an instruction to pay a reward or make a payment is stored into the blockchain, service server 30 can enable the reward smart contract. Furthermore, when the item positive-obtainment information is recorded into the blockchain, service server 30 may carry out the reward smart contract so that the coin is issued.

### 3 Operation, Etc., of Terminal 10A

Next, the outline of the operation of terminal 10A carried by user A in the control system configured as described above will be described.

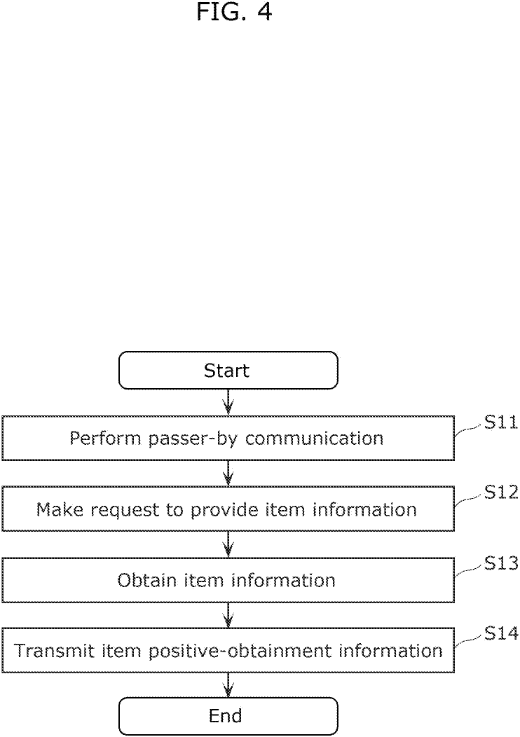

FIG. 4 is a flowchart showing the outline of the operation of terminal 10A according to Embodiment 1. FIG. 4 shows the operation of terminal 10A performed when terminal 10A, terminal 10B, and service server 30 are not included in a blockchain network.

First, terminal 10A performs the passer-by communication (S11). More specifically, terminal 10A carried by user A establishes the short-range wireless communication with terminal 10B carried by user B. To describe using the example illustrated in FIG. 1, during movement of user A, wilen terminal 10A carried by user A comes close enough to perform the short-range wireless communication with terminal 10B carried by user B, terminal 10A establishes the short-range wireless communication with terminal 10B.

Next, terminal 10A makes a request for the item information (S12). More specifically, using the identification information of at least one of the one or more items worn by user B that has been obtained upon the establishment of the short-range wireless communication, terminal 10A requests service server 30 via network N to provide the item information of said item. To describe using the example illustrated in FIG. 2, when user A is interested in an item worn by user B, user A requests service server 30 to provide the item information of said item using the identification information of said item obtained upon the establishment of the short-range wireless communication. Note that the identification information of said item may be obtained from the RFID tag attached to the item worn by user B or may be obtained from terminal 10B.

Next, terminal 10A obtains the item information (S13). More specifically, terminal 10A obtains the item information from service server 30. Note that the item information is, for example, a URL from which online information about at least one of the one or more items worn by user B is accessible.

Next, terminal 10A transmits the item positive-obtainment information (S14). More specifically, terminal 10A transmits, to service server 30, the item positive-obtainment information indicating that the item information has been obtained.

This allows terminal 10A to obtain, from service server 30, a coupon that is usable in an online store where the item indicated in the item positive-obtainment information is available for purchase as merchandise. Meanwhile, to terminal 10B of user B, service server 30 issues a coin as a reward of the obtainment of the item information, for example.

In this manner, user B can advertise a physical item using the passer-by communication in which terminal 10B or item tag 20 is used.

### 4 Processes of Control System

Next, the processes of the control system configured as described above will be described.

### 4.1 Processes Performed When Not Included in Blockchain Network

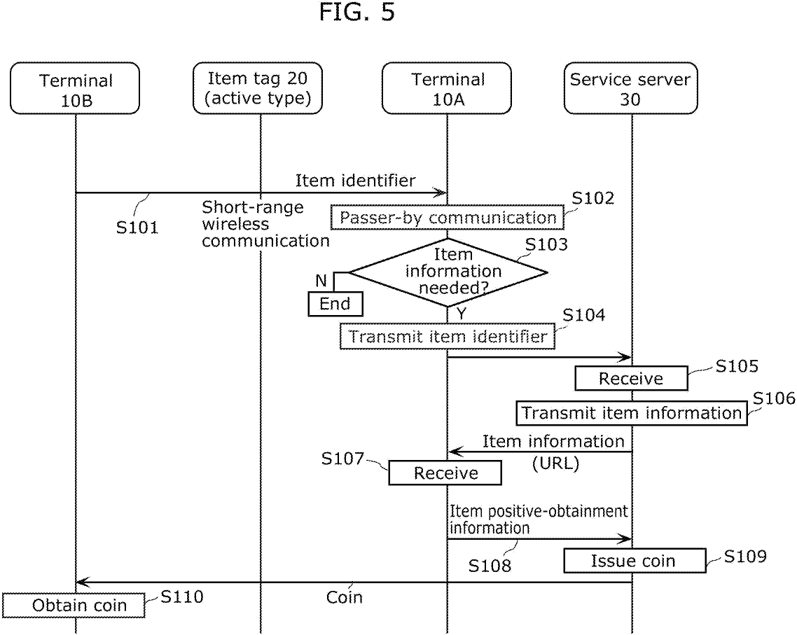

FIG. 5 is a first sequence chart showing the processes of the control system according to Embodiment 1.

The first sequence chart shown in FIG. 5 represents the processes of the control system that are performed when terminal 10A, terminal 10B, and service server 30 are not included in a blockchain network.

First, assume that after information of a list of items worn by user B is registered in terminal 10B, user B is moving around town to advertise the items worn by user B. Furthermore, assume that terminal 10B carried by user B transmits the item identifier via the short-range wireless communication (S101). More specifically, terminal 10B broadcasts predetermined communication signals such as beacon signals via the short-range wireless communication, and the predetermined communication signals include the item identifier. The item identifier is one example of the identification information of each of the items worn by user B.

Meanwhile, assume that user A carrying terminal 10A is moving around town, and as a result of approaching user B until user A is located a predetermined distance from user B, terminal 10A carried by user A and terminal 10B carried by user B come close enough to perform the short-range wireless communication. Then, terminal 10A obtains the item identifier and performs the passer-by communication with terminal 10B (S102). In other words, terminal 10A carried by user A obtains the item identifier upon the establishment of the short-range wireless communication with terminal 10B carried by user B. Terminal 10A or terminal 10B may notify user A or user B that the passer-by communication has been performed. Furthermore, terminal 10A may notify user A that the item identifier has been obtained. The voice and sound effect, the vibration effect, the light-emitting effect, and the like of terminal 10A or terminal 10B may be controlled to provide the notification to user A or user B.

Next, terminal 10A checks whether user A has indicated that the item information of at least one item is needed (S103). In the present exemplary embodiment, it is assumed that user A is interested in an item worn by user B carrying terminal 10B with which terminal 10A has performed the passer-by communication. Therefore, by specifying the item identifier of the item that user A is interested in among the item identifiers obtained by terminal 10A, user A indicates that the item information of the item corresponding to the item identifier is needed. Note that when user A is not interested in the items worn by user B carrying terminal 10B with which terminal 10A has performed the passer-by communication, user A does not specify any of the item identifiers obtained by terminal 10A.

When it is confirmed in Step S103 that user A has indicated that the item information is needed (Y in S103), terminal 10A transmits, to service server 30, the item identifier specified by user A (S104). In this manner, terminal 10A makes a request for the item information. Note that when it cannot be confirmed in Step S103 that user A has indicated that the item information is needed (N in S103), terminal 10A ends the processes in the first sequence.

Next, service server 30 receives the item identifier transmitted from terminal 10A (S105).

Next, service server 30 transmits, to terminal 10A, the item information corresponding to the received item identifier (S106). The item information is a URL from which online information about the item corresponding to the item identifier specified by user A is accessible.

Next, terminal 10A receives the item information transmitted from service server 30 (S107). In this manner, terminal 10A obtains the item information. Terminal 10A may display the obtained item information on display 16.

Next, terminal 10A transmits, to service server 30, the item positive-obtainment information indicating that the item information has been obtained (S108).

Next, when service server 30 receives the item positive-obtainment information from terminal 10A, service server 30 issues a coin to terminal 10B of user B who advertises the item included in the item information transmitted to terminal 10A (S109).

Next, terminal 10B obtains the coin issued by service server 30 (S110).

In this manner, using the passer-by communication in which terminal 10B is used, user B can advertise a physical item worn by user B.

### 4.2 Processes Performed When Included in Blockchain Network

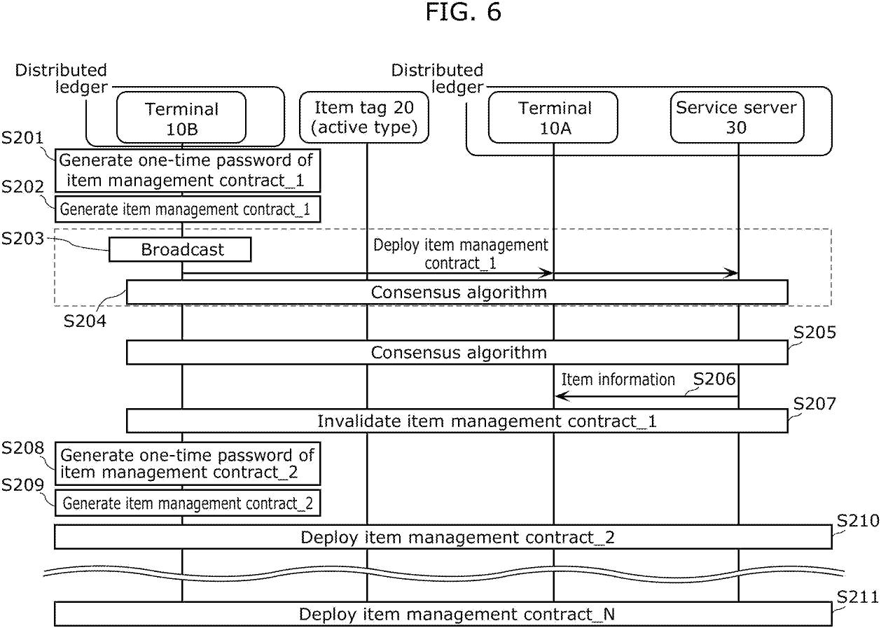

FIG. 6 is a second sequence chart showing the processes of the control system according to Embodiment 1.

The second sequence chart shown in FIG. 6 shows the processes of the control system in which the item management contract is generated and then invalidated when terminal 10A, terminal 10B, and service server 30 are included in a blockchain network. In FIG. 6, a distributed ledger is indicated as one example of the blockchain.

First, using terminal 10B, user B generates a one-time password of item management contract_1 (S201) and generates item management contract_1 (S202).

Here, item management contract_1 is a smart contract for managing the item identifier, the item information, and the one-time password of each of the one or more items worn by user B.

Next, terminal 10B generates and broadcasts transaction data including item management contract_1 generated in Step S202 (S203), thus transmitting the transaction data to terminal 10A and service server 30.

Next, terminal 10A, terminal 10B, and service server 30 execute the consensus algorithm (S204). More specifically, when terminal 10A, terminal 10B, and service server 30 each verify that the transaction data including item management contract_1 is valid (that is, validity), terminal 10A, terminal 10B, and service server 30 generate a block including the transaction data. Subsequently, each of terminal 10A, terminal 10B, and service server 30 stores the block including the transaction data into a corresponding distributed ledger. Since a block including transaction data, the validity of which has been successfully verified, is stored into the distributed ledger, unnecessary memory usage can be reduced. In this manner, terminal 10A, terminal 10B, and service server 30 deploy item management contract_1. Note that deploying item management contract_1 means deploying a contract code, which is a program, of the substance of item management contract_1 onto the blockchain network.

Subsequently, assume that in Step S205, the transaction data including the one-time password of item management contract_1 and the item identifier specified by user A is stored into the distributed ledger via the consensus algorithm.

Thus, service server 30 transmits, to terminal 10A, the item information of the item corresponding to the item identifier specified by user A (S206), and item management contract_1 is invalidated (S207).

Next, since item management contract_1 is invalidated, using terminal 10B, user B generates the one-time password of next item management contract_2 (S208) and generates item management contract_2 (S209).

Next, terminal 10A, terminal 10B, and service server 30 deploy item management contract_2 as with item management contract_1 (S210).

Furthermore, when item management contract_2 is invalidated after item management contract_2 is deployed, user B generates next item management contract_3. In this manner, generation and invalidation of item management contract _N are repeated. Thus, it can be ensured that even when the item identifier is obtained using a means other than the passer-by communication, the item information will not be obtained. As a result, it is possible to keep rewards such as coins from being provided to terminal 10B when the passer-by communication is not performed.

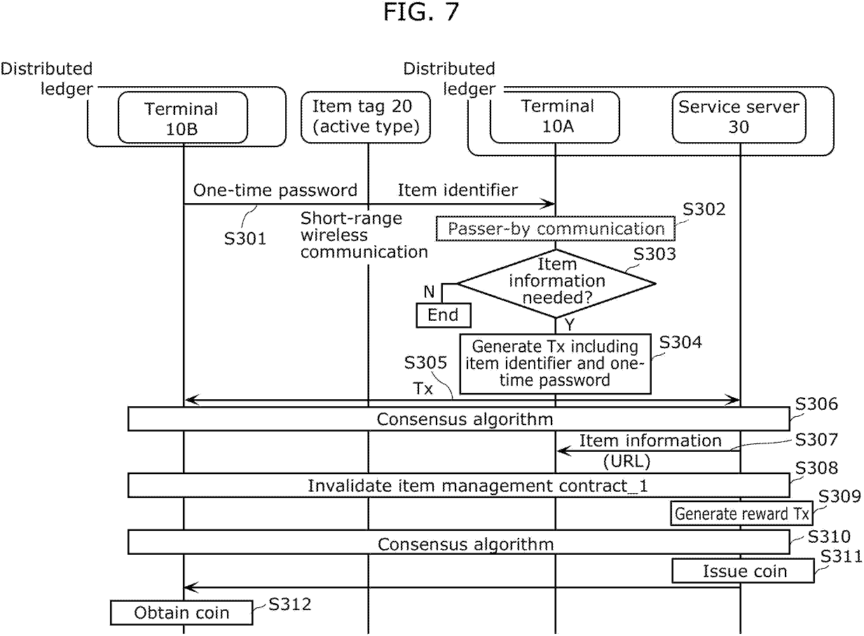

FIG. 7 is a third sequence chart showing the processes of the control system according to Embodiment 1.

The third sequence chart shown in FIG. 7 represents the processes of the control system that are performed until feasible item management contract_1 is invalidated when terminal 10A, terminal 10B, and service server 30 are included in a blockchain network. In FIG. 7, a distributed ledger is indicated as one example of the blockchain. The following will mainly describe features different from the features described with reference to FIG. 5.

First, assume that after information of a list of items worn by user B is registered in terminal 10B, user B is moving around town to advertise the items worn by user B. In this case, terminal 10B carried by user B transmits the one-time password and the item identifier via the short-range wireless communication (S301). More specifically, terminal 10B broadcasts predetermined communication signals such as beacon signals via the short-range wireless communication, and the predetermined communication signals include the one-time password and the item identifier.

Meanwhile, assume that user A carrying terminal 10A is moving around town, and as a result of approaching user B until user A is located a predetermined distance from user B, terminal 10A carried by user A and terminal 10B carried by user B come close enough to perform the short-range wireless communication. Then, terminal 10A obtains the one-time password and the item identifier and performs the passer-by communication with terminal 10B (S302). In this manner, upon the establishment of the short-range wireless communication with terminal 10B carried by user B, terminal 10A carried by user A obtains the one-time password and the item identifier of at least one of the one or more items worn by user B via the short-range wireless communication.

Next, terminal 10A checks whether user A has indicated that the item information of at least one item is needed (S303). In the present exemplary embodiment, by specifying the item identifier of the item that user A is interested in among the item identifiers obtained by terminal 10A, user A indicates that the item information of the item corresponding to the item identifier is needed.

When it is confirmed in Step S303 that user A has indicated that the item information is needed (Y in S303), terminal 10A generates transaction data including the one-time password and the item identifier specified by user A (S304). In this manner, terminal 10A generates transaction data including the one-time password and the identification information of at least one item. Note that when it cannot be confirmed in Step S303 that user A has indicated that the item information is needed (N in S303), terminal 10A ends the processes in the third sequence.

Next, terminal 10A broadcasts the transaction data generated in Step S304 and thus transmits the transaction data to terminal 10B and service server 30 (S305). Note that the transaction data generated in Step S304 may further include the contract address of item management contract_1.

Next, terminal 10A, terminal 10B, and service server 30 that have obtained the transaction data generated in Step S304 execute the consensus algorithm (S306).

More specifically, when terminal 10A, terminal 10B, and service server 30 each verify that the transaction data is valid (that is, validity), terminal 10A, terminal 10B, and service server 30 generate a block including the transaction data. Subsequently, each of terminal 10A, terminal 10B, and service server 30 stores the block including the transaction data into a corresponding distributed ledger. In this manner, terminal 10A broadcasts the generated transaction data and thus can record the transaction data into the blockchain.

Furthermore, terminal 10A, terminal 10B, and service server 30 input, to item management contract_1 stored in the distributed ledger, the transaction data included in the block. Thus, item management contract_1 is carried out using the one-time password included in the transaction data and the item identifier specified by user A as input values.

Next, terminal 10A obtains the item information of the item corresponding to the item identifier specified by user A that is output of item management contract_1 (S307). Note that the item information is a URL from which online information about the item corresponding to the item identifier specified by user A is accessible. In this manner, terminal 10A obtains the item information. Specifically, when there is a match between the password recorded in the blockchain and the one-time password obtained by terminal 10A, terminal 10A can obtain the item information.

Next, item management contract_1 is invalidated after the item information of the item corresponding to the item identifier specified by user A is output (S308).

Next, service server 30 generates reward transaction data for terminal 10B of user B who advertises the item included in the item information that has been output to terminal 10A according to item management contract_1 (S309).

Next, when the reward transaction data generated in Step S309 is obtained, terminal 10A, terminal 10B, and service server 30 execute the consensus algorithm (S310). More specifically, when terminal 10A, terminal 10B, and service server 30 each verify that the reward transaction data is valid (that is, validity), terminal 10A, terminal 10B, and service server 30 generate a block including the reward transaction data. Subsequently, each of terminal 10A, terminal 10B, and service server 30 stores the block including the reward transaction data into a corresponding distributed ledger. Then, terminal 10A, terminal 10B, and service server 30 input, to the reward smart contract stored in the distributed ledger, the transaction data included in the block. Thus, the reward smart contract is carried out using the reward transaction data as input values.

Next, service server 30 causes the reward smart contract carried out using the reward transaction data as input values to issue a coin (S311) and transmits the issued coin to terminal 10B.

Next, terminal 10B obtains the coin issued by service server 30 (S312).

In the above-described manner, using the passer-by communication in which terminal 10B is used, user B can advertise a physical item worn by user B.

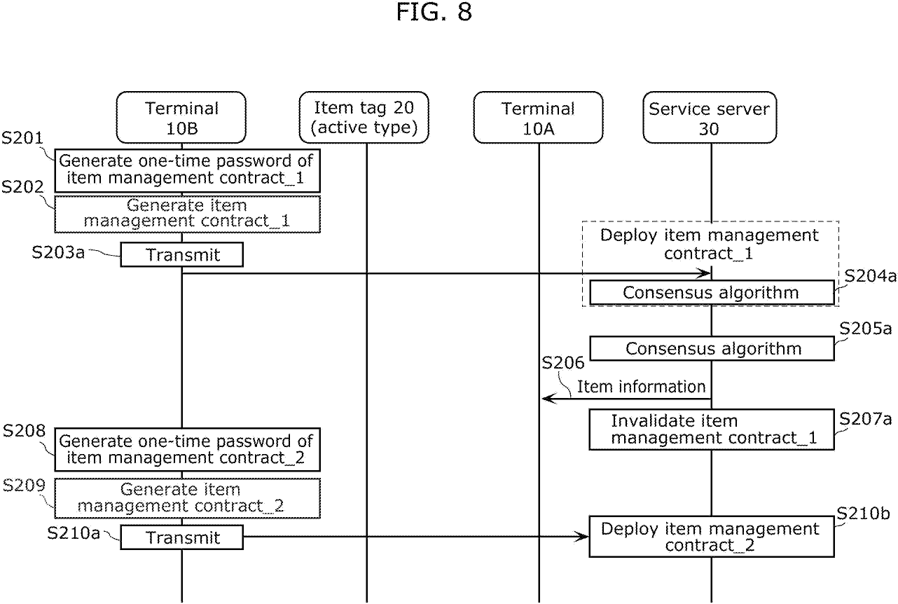

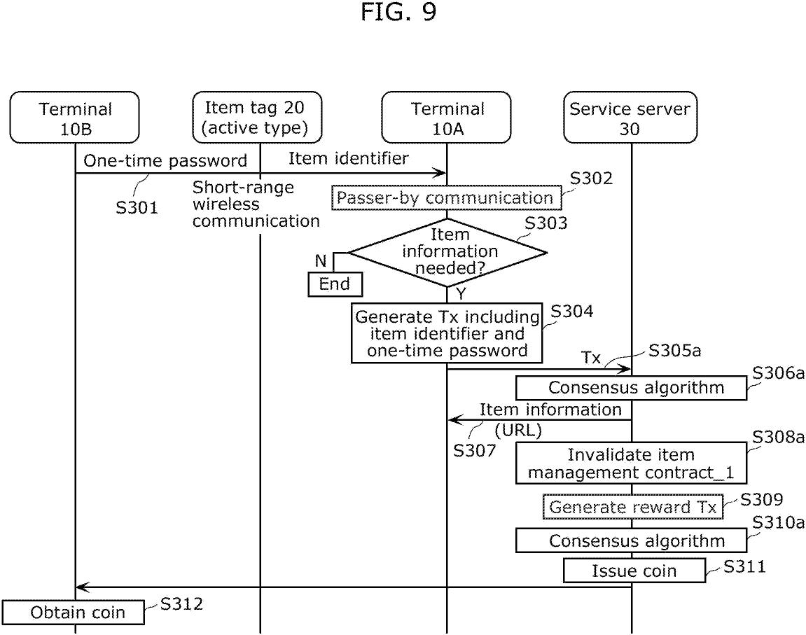

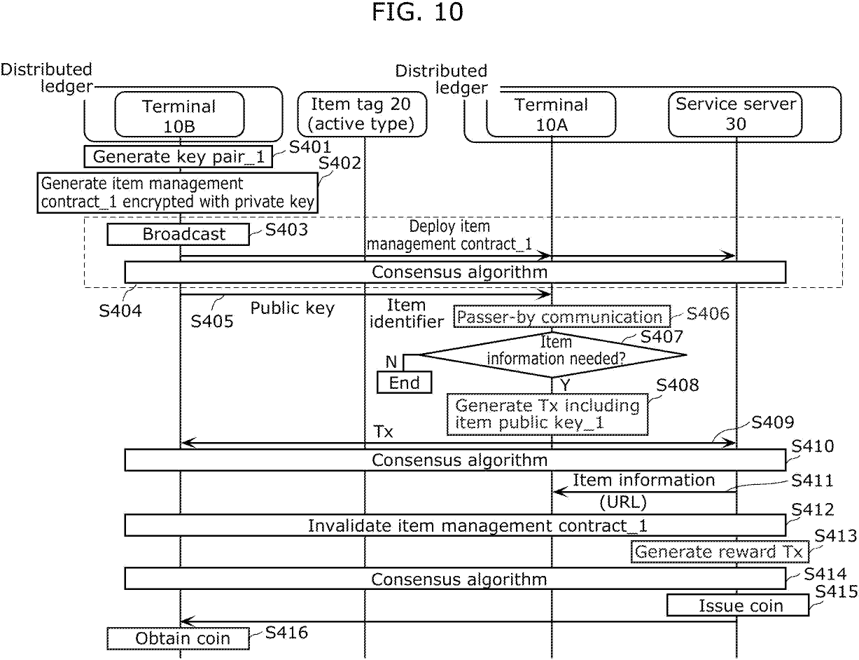

Note that the processes performed when terminal 104A, terminal 10B, and service server 30 are included in a blockchain network are described with reference to FIG. 6 and FIG. 7, but this is not limiting. The blockchain network may include only service server 30. The processes performed in this case will be described with reference to FIG. 8 and FIG. 9.

FIG. 8 is a fourth sequence chart showing the processes of the control system according to Embodiment 1. Note that elements substantially the same as those illustrated in FIG. 6 are assigned the same reference signs and detailed description thereof will be omitted.

The fourth sequence chart shown in FIG. 8 shows the processes of the control system in which the item management contract is generated and then invalidated when the blockchain network includes only service server 30. The following will describe only the points of difference from the second sequence chart shown in FIG. 6.

In Step S203a and Step S210a, terminal 10B transmits generated item management contract_1and item management contract 2 to service server 30.

In Step S204a and Step S205a, only service server 30 executes the consensus algorithm.

In Step S207a, since item management contract_1 is deployed only on the blockchain, that is, in the distributed ledger, of service server 30, item management contract_1 is invalidated only in the distributed ledger of service server 30.

Similarly, in Step S210b, item management contract_2 is deployed only in the distributed ledger of service server 30.

FIG. 9 is a fifth sequence chart showing the processes of the control system according to Embodiment 1. Elements substantially the same as those illustrated in FIG. 7 are assigned the same reference signs and detailed description thereof will be omitted.

The fifth sequence chart shown in FIG. 9 represents the processes of the control system that are performed until feasible item management contract_1 is invalidated when the blockchain network includes only service server 30. The following will describe only the points of difference from the third sequence chart shown in FIG. 7.

In Step S305a, terminal 10A transmits the generated transaction data to service server 30 only.

In Step S306a and Step S310a, service server 30 alone executes the consensus algorithm.

In Step S308a, since item management contract_1 is deployed only on the blockchain, that is, in the distributed ledger, of service server 30, item management contract_1 is invalidated only in the distributed ledger of service server 30.

### Variation

Note that with reference to FIG. 6 to FIG. 9, the foregoing has described the case where the one-time password is used in order to prevent the item information from being obtained when the passer-by communication is not performed, but this is not limiting. Substantially the same operation is possible when public-key cryptography is used. Hereinafter, an example of the processes performed in this case will be described with reference to FIG. 10.

FIG. 10 is a sequence chart showing processes of a control system according to a variation of Embodiment 1. The following will mainly describe processes different from those in the second sequence chart shown in FIG. 6 and the third sequence chart shown in FIG. 7.

The sequence chart shown in FIG. 10 shows the processes of the control system that are performed between generation of the item management contract and invalidation of the item management contract when terminal 10A, terminal 10B, and service server 30 are included in a blockchain network. In FIG. 10, a distributed ledger is indicated as one example of the blockchain.

First, using terminal 10B, user B generates key pair_1 including a public key and a private key in the public key cryptography (S401) and generates item management contract_1.

Next, using terminal 10B, user B generates item management contract_1 encrypted with the private key generated in Step S401 (S402).

Next, terminal 10B generates and broadcasts transaction data including encrypted item management contract_1 (S403), thus transmitting the transaction data to terminal 10A and service server 30.

Next, terminal 10A, terminal 10B, and service server 30 execute the consensus algorithm (S404). In this manner, terminal 10A, terminal 10B, and service server 30 deploy encrypted item management contract_1.

Assume that after information of a list of items worn by user B is registered in terminal 10B, user B is moving around town to advertise the items worn by user B. In this case, terminal 10B carried by user B transmits the public key included in key pair_1 generated in Step S401 and the item identifier via the short-range wireless communication (S405). More specifically, terminal 10B broadcasts predetermined communication signals such as beacon signals via the short-range wireless communication, and the predetermined communication signals include the public key and the item identifier.

Meanwhile, assume that user A carrying terminal 10A is moving around town, and terminal 10A carried by user A and terminal 10B carried by user B come close enough to perform the short-range wireless communication. Then, terminal 10A obtains the public key and the item identifier and performs the passer-by communication with terminal 10B (S406). In this manner, upon the establishment of the short-range wireless communication with terminal 10B carried by user B, terminal 10A carried by user A obtains the public key and the item identifier of at least one of the one or more items worn by user B from terminal 10B via the short-range wireless communication.

Next, terminal 10A checks whether user A has indicated that the item information of at least one item is needed (S407). In the present variation, by specifying the item identifier of the item that user A is interested in among the item identifiers obtained by terminal 10A, user A indicates that the item information of the item corresponding to the item identifier is needed.

When it is confirmed in Step S407 that user A has indicated that the item information is needed (Y in S407), terminal 10A generates transaction data including public key_1 and the item identifier specified by user A (S408). In this manner, terminal 10A generates transaction data including the public key and the identification information of at least one item. Note that when it cannot be confirmed in Step S407 that user A has indicated that the item information is needed (N in S407), terminal 10A ends the processes in the present sequence.

Next, terminal 10A broadcasts the transaction data generated in Step S408 and thus transmits the transaction data to terminal 10B and service server 30 (S409).

Next, when the transaction data transmitted in Step S409 is obtained, terminal 10A, terminal 10B, and service server 30 execute the consensus algorithm (S410). In this manner, terminal 10A broadcasts the generated transaction data and thus can record the transaction data into the blockchain.

Furthermore, terminal 10A, terminal 10B, and service server 30 input, to item management contract_1 stored in the distributed ledger, the transaction data included in the block. Thus, using the item identifier specified by user A as an input value, item management contract_1 decoded with the public key included in the transaction data is carried out.

Next, terminal 10A obtains the item information of the item corresponding to the item identifier specified by user A that is output of item management contract_1 (S411). Thus, in the present variation, when there is a match between the public key recorded in the blockchain and the private key held by terminal 10B, terminal 10A can obtain the item information transmitted thereto.

Subsequent Steps S412 to S416 are substantially the same as Steps S308 to S312 shown in FIG. 7 and therefore, description thereof will be omitted.

In the above-described manner, using the passer-by communication in which terminal 10B is used, user B can advertise a physical item worn by user B.

Furthermore, by using the public key, it is possible to inhibit disguised passer-by communication that is performed while being at home. In other words, it can be ensured that even when the item identifier is obtained using a means other than the passer-by communication, the item information will not be obtained. As a result, it is possible to keep rewards such as coins from being provided to terminal 10B when the passer-by communication is not performed.

### 4.3 Use Case

The following will describe an overview of a use case according to the present disclosure that involves the above-described physical item advertising in which the passer-by communication is used.

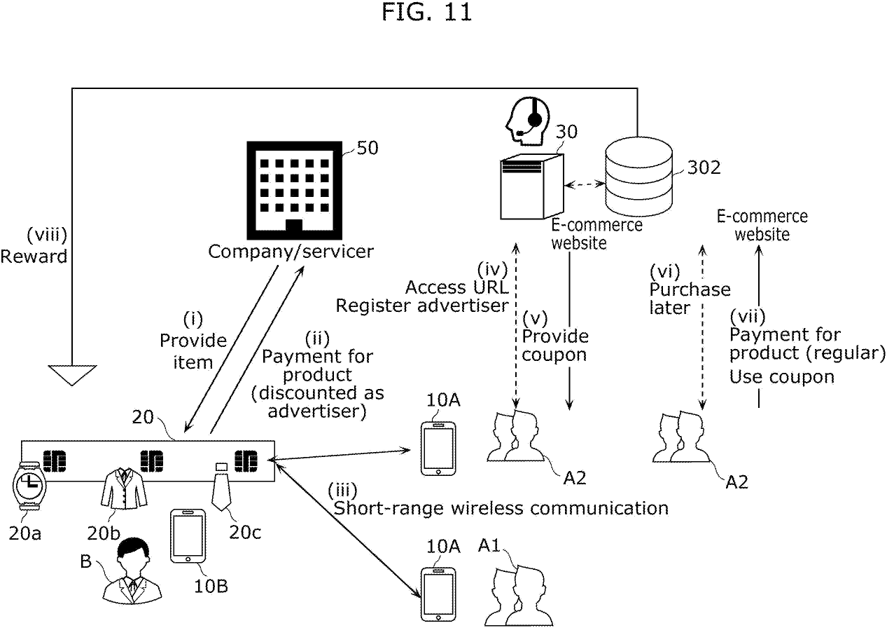

FIG. 11 is a diagram schematically showing an overview of a use case according to Embodiment 1.

First, as shown in (i) in FIG. 11, company/servicer 50 which intends to promote the purchase of an item by advertising the item provides the item to user B. Then, as shown in (ii) in FIG. 11, user B pays company/servicer 50 for a product that is the provided item. The payment for the product in this case is discounted as an advertiser because user B advertises the physical item using the passer-by communication. In the example shown in FIG. 11, the item provided by company/servicer 50 is watch 20a, jacket 20b, tie 20c, or the like to be worn by user B. Note that the item provided by company/servicer 50 has an active RFID tag attached thereto that transmits the item identifier of said item in the form of beacon signals or the like. It goes without saying that the item does not need to have the active RFID tag attached thereto; in this case, it is sufficient that user B register, in terminal 10B, the information of a list of items worn by user B.

Next, user B is moving around town to advertise the items worn by user B, and the RFID tag on each of the items worn by user B transmits the item identifier thereof in the form of beacon signals or the like. Note that terminal 10B carried by user B may transmit the item identifier via the short-range wireless communication. Meanwhile, user A carrying terminal 10A is moving around town.

Subsequently, terminal 10A carried by user A and terminal 10B or the RFID tag on the item worn by user B come close enough to perform the short-range wireless communication, as shown in (iii) in FIG. 11. In this case, the item identifier is obtained via the short-range wireless communication from terminal 10B or each of the items worn by user B. The example shown in FIG. 11 shows that user A is interested in an item worn by user B, but there are cases where user A wants the item information which is the URL for the item and cases where user A does not want the item information which is the URL for the item. In FIG. 11, user A who does not want the item information is denoted as user A1, and user A who wants the item information is denoted as user A2.

Next, when user A2 obtains the item information, i.e., the URL, on the basis of the obtained item identifier, user A2 accesses the URL and checks the item on an electronic commerce (E-commerce) website operated by service server 30, as illustrated in (iv) in FIG. 11. At this time, service server 30 registers, as an advertiser, user B who has provided the URL.

Then, service server 30 provides a coupon to user A2, as illustrated in (v) in FIG. 11. This can lead to the action of purchasing the accessed item.

For example, in the case where user A2 purchases the item at a later date after the coupon is provided as illustrated in (vi) in FIG. 11, user A2 pays for the item with a regular price using the provided coupon as illustrated in (vii) in FIG. 11.

Then, service server 30 that operates the E-commerce website pays a reward to terminal 10B as illustrated in (viii) in FIG. 11.

In this manner, user B can obtain a reward when the physical item advertising in which the passer-by communication is used results in access to the URL for the item or the purchase of the item, for example. Such an arrangement where rewards can be obtained serves as an incentive for user B to advertise a physical item using the passer-by communication. Furthermore, by using the physical item advertising in which the passer-by communication is used, company/servicer 50 can encourage people to take actions to purchase the item including accessing the URL for the item and actually purchasing the item, for example.

### 5 Advantageous Effects, Etc.

As described above, with the control method, etc., according to the present disclosure, using the first terminal that has established the short-range wireless communication with the second terminal of the second user via the passer-by communication, the first user obtains the item information of at least one item among the physical items worn by the second user, and transmits the item positive-obtainment information to the server. In other words, the second user can advertise, to the first user, an item actually worn by him or herself and can encourage the first user to obtain the item information, which is one action that may lead to closing of a transaction of said item.

In this manner, physical item advertising is possible using the passer-by communication; thus, it is possible to encourage the first user to take an action to purchase the item.

Furthermore, with the control method, etc., according to the present disclosure, a coupon that is usable in an online store where the item can be purchased can be issued to the first terminal; therefore, it is possible to encourage the first user carrying the first terminal to take an action to purchase the item.

Furthermore, with the control method, etc., according to the present disclosure, when the first user is successfully encouraged to take an action leading to the purchase of the item such as the obtainment of the item information, the second user can obtain, as a reward, a coin issued by the seller of the item, for example, Such an incentive can motivate the second user to engage in the physical item advertising in which the passer-by communication is used.

### Embodiment 2

In Embodiment 1, terminal 10A and terminal 10B are described as establishing the short-range wireless communication when terminal 10A and terminal 10B are located close enough to perform the short-range wireless communication.

However, there are cases where a device other than terminal 10B may be located close enough to terminal 10A to perform the short-range wireless communication. In this case, terminal 10B needs to be selected to establish the short-range wireless communication, which is a cumbersome operation for user A carrying terminal 10A.

In view of this, the present exemplary embodiment will describe a user interface (UI) that allows user A to select where to connect, that is, terminal 10B with which the short-range wireless communication is to be established, through simpler operation.

The following description is based on the assumption that the short-range wireless communication is performed using Bluetooth Low Energy (BLE) and BLE beacons, which are beacon signals for smartphones, are used as the beacon signals.

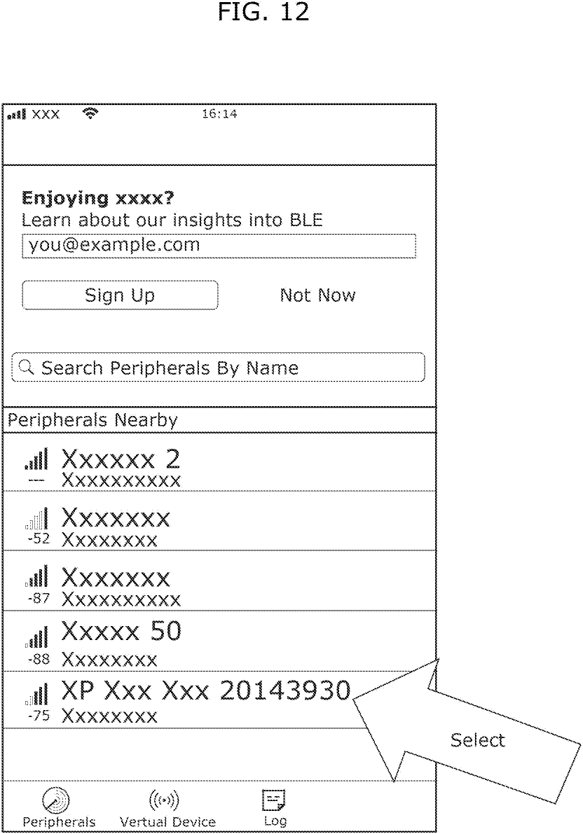

FIG. 12 is a diagram showing one example of a BLE connection selecting UI according to a comparative example.

FIG. 12 shows an example where when terminal 10A and terminal 10B are located close enough to perform the short-range wireless communication, five selectable device names and radio signal strength thereof are displayed.

As shown in FIG. 12, it is unknown which of the selectable device names corresponds to terminal 10B unless prior information is available. Therefore, it is necessary to infer, from the radio signal strength and the device names, which of the device names corresponds to terminal 10B or item tag 20, which is cumbersome for user A carrying terminal 10A. Note that in FIG. 12, the device name indicated to be selected corresponds to terminal 10B.

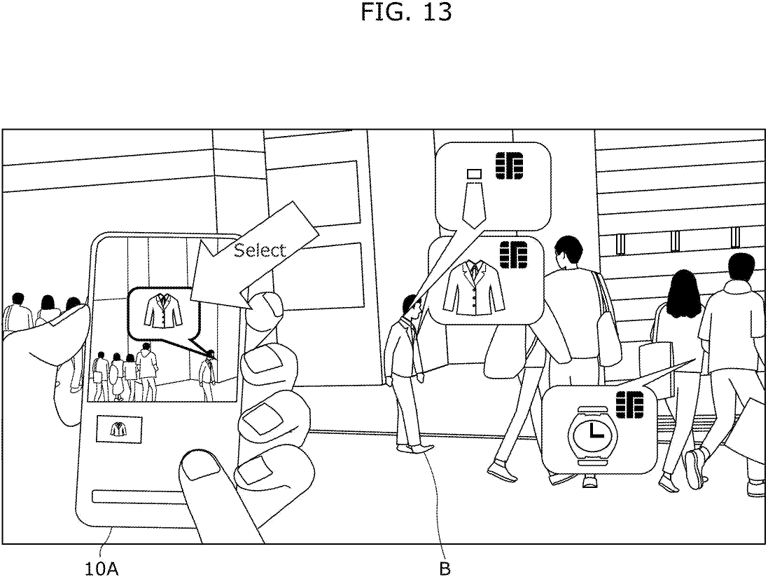

FIG. 13 is a diagram showing one example of a short-range wireless communication connection selecting UI according to Embodiment 2.

FIG. 13 shows an example of the case where when terminal 10A and terminal 10B are located close enough to perform the short-range wireless communication, user A can select where to connect on the screen.

In a situation in the example shown in FIG. 13, beacon signals transmitted from the RFID tags attached to the items worn by user B and another user are received, and by selecting an image appearing on the screen of terminal 10A, user A selects terminal 10B as a destination to which terminal 10A is to be connected. Furthermore, in the situation in the example shown in FIG. 13, user A can select an image of the item worn by user B that is projected on the screen of terminal 10A, to perform the operation to obtain the item information of said item.

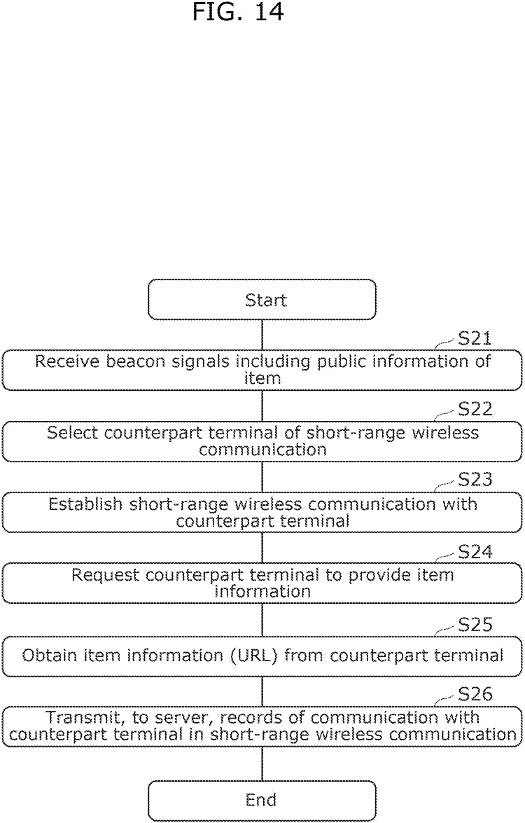

FIG. 14 is a flowchart showing one example of the operation of terminal 10A according to Embodiment 2. Note that FIG. 14 shows the operation of terminal 10A performed when terminal 10A, terminal 10B, and service server 30 are not included in a blockchain network. Furthermore, in the example shown in FIG. 14, the item identifier is obtained from item tag 20, and the item information is obtained from terminal 10B.

Here, assume that user B has registered in terminal 10B the item information of the items worn by user B together with the item identifiers and user B is moving around town to advertise the items worn by user B. Furthermore, assume that user B has enabled the RFID tags attached to the items worn by user B to cause the RFID tags to transmit beacon signals. Meanwhile, user A carrying terminal 10A is moving around town. One example of the operation of terminal 10A performed in this case will be described below.

First, as shown in FIG. 14, terminal 10A receives beacon signals including public information of an item (S21). More specifically, terminal 10A receives predetermined communication signals transmitted from the RFID tags attached to one or more items worn by user B and including information indicating the identification information of said one or more items and the location of product information of said one or more items. Note that the public information of an item, which is information that has been made public to advertise the item worn by user B, includes the item identifier of said item and URL or the like on the Internet from which an image of said item or product information including an image of said item can be obtained. The URL corresponds to the information indicating the location of the product information. In the present exemplary embodiment, when terminal 10 receives the beacon signals including the public information of the item, user A is notified with vibrations, voice and/or sound, light emitted from a light, or the like that the beacon signals have been obtained.

Next, terminal 10A selects a counterpart terminal of the short-range wireless communication (S22). In the present exemplary embodiment, terminal 10A notifies user A that the beacon signals have been obtained, and an image included in the beacon signals or an image obtained by accessing the URL is displayed on display 16 of terminal 10A. When user A is interested in an item worn by user B, user A can select terminal 10B as a counterpart terminal of the short-range wireless communication by selecting said image by touching said image, for example.

Next, terminal 10A establishes the short-range wireless communication with the counterpart terminal selected in Step S22 (S23). In the present exemplary embodiment, user A holds up terminal 10A to user B, and thus terminal 10A obtains a surrounding image including user B from camera 15 included in terminal 10A. When the item worn by user B is included in the surrounding image, terminal 10A establishes the short-range wireless communication with terminal 10B. Subsequently, terminal 10A superimposes, onto the surrounding image, the product information of the item obtained on the basis of the URL on the Internet, and displays the surrounding image on display 16 included in terminal 10A.

Next, terminal 10A requests the counterpart terminal with which the short-range wireless communication has been established in Step S23 to provide the item information (S24). In the present exemplary embodiment, using the item identifier of said item obtained from item tag 20, i.e., the RFID tag, terminal 10A requests terminal 10B via the short-range wireless communication to provide the item information of said item.

Next, terminal 10A obtains the item information from the counterpart terminal (S25). In the present exemplary embodiment, terminal 10A obtains the item information from terminal 10B.

At the end, terminal 10A transmits, to the server, records of communication with the counterpart terminal in the short-range wireless communication (S26). In the present exemplary embodiment, the records of communication performed with the counterpart terminal in the short-range wireless communication include the item positive-obtainment information indicating that the item information has been obtained from terminal 10B, for example. Therefore, terminal 10A transmits the item positive-obtainment information indicating that the item information has been obtained from terminal 10B, to service server 30 as the records of communication performed with the counterpart terminal in the short-range wireless communication.

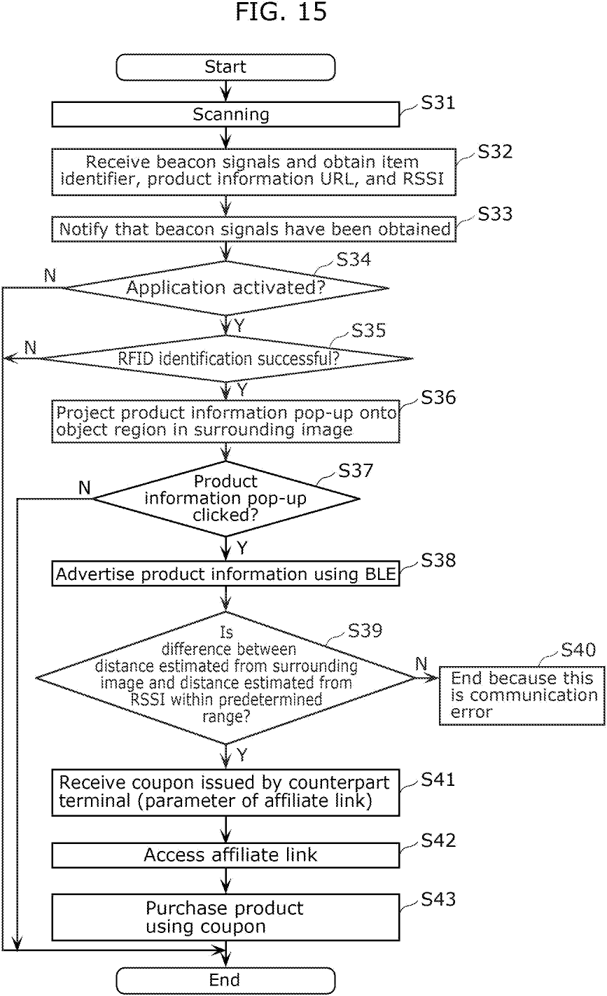

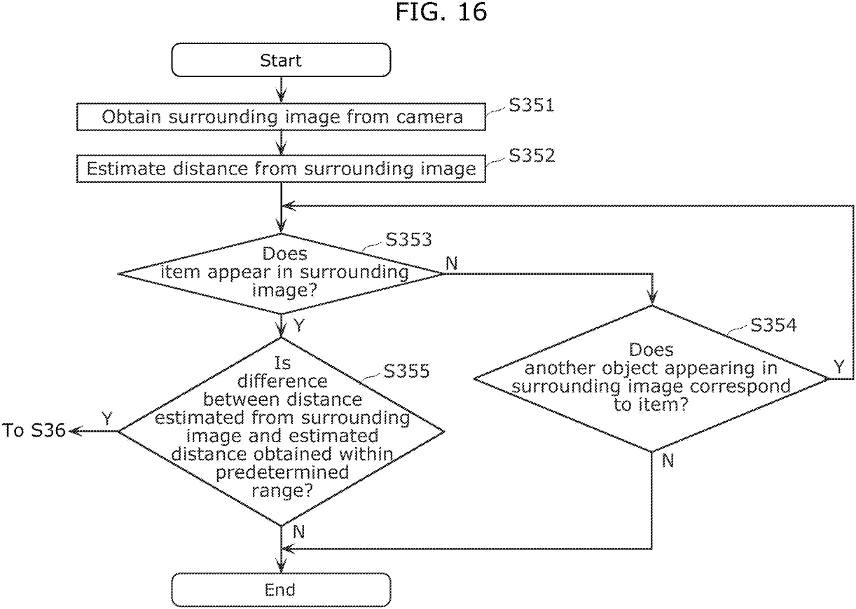

FIG. 15 is a flowchart showing another example of the operation of terminal 10A according to Embodiment 2. FIG. 16 is a flowchart showing a detailed operation of Step S35 shown in FIG. 15. Note that FIG. 16 shows the operation of terminal 10A performed when terminal 10A, terminal 10B, and service server 30 are not included in a blockchain network. Furthermore, in the example shown in FIG. 16, the item identifier is obtained from item tag 20, and the item information is obtained from terminal 10B.

First, terminal 10A scans the beacon signals transmitted thereto (S31). In the present exemplary embodiment, since the beacon signals are transmitted from item tag 20, i.e., the RFID tag, attached to the item worn by user B, terminal 10A receives the beacon signals by scanning.

Next, by receiving the beacon signals, terminal 10A obtains the item identifier and a product information URL included in the beacon signals, and obtains a received signal strength indicator (RSSI) of the beacon signals (S32). In the present exemplary embodiment, by receiving the RSSI of the beacon signals, terminal 10A can obtain the radio signal strength of the RFID tag attached to each of the one or more items. The product information URL is a URL on the Internet from which an image of the item can be obtained as mentioned above. Note that there are cases where terminal 10A obtains an image of the item, instead of the product information URL, from item tag 20, i.e., the RFID tag.

Next, terminal 10A notifies user A that the beacon signals have been obtained (S33). In the present exemplary embodiment, terminal 10A notifies user A with vibrations or the like that the beacon signals have been obtained.

Next, terminal 10A checks whether an application has been activated (S34). In the present exemplary embodiment, terminal 10A checks whether an application that operates the short-range wireless communication connection selecting UI described with reference to FIG. 13, for example, has been activated.

When the application has been activated in Step S34 (Y in S34), terminal 10A checks whether the RFID identification has been successful (S35). Note that when the application has not been activated in Step S34 (N in S34), the processing ends.

Hereinafter, Step S35 will be described in detail. Specifically, in Step S35, first, terminal 10A obtains a surrounding image from camera 15 included in terminal 10A itself, as shown in FIG. 16, for example (S351). In the present exemplary embodiment, as mentioned above, user A holds up terminal 10A to user B, and thus terminal 10A obtains a surrounding image including user B from camera 15 included in terminal 10A itself.

Next, terminal 10A estimates the distance to the item worn by user B from the surrounding image obtained in Step S351 (S352). Since the item worn by user B and terminal 10B of user B are located at the same distance, terminal 10A and terminal 10B establish the short-range wireless communication using the distance to the item. In the present exemplary embodiment, terminal 10A extracts, from the surrounding image obtained in Step S351, a region in which user B or terminal 10B is located, and recognizes an object that is the item worn by user B. Subsequently, terminal 10A estimates the distance between the recognized object and terminal 10A. In this manner, terminal 10A obtains distance information indicating the distance from terminal 10A to each of the one or more items included in the surrounding image.

Subsequently, terminal 10A checks whether the item appears in the surrounding image obtained in Step S351 (S353).

When the item appears in the surrounding image in Step S353 (Y in S353), it is checked whether the difference between the distance estimated from the surrounding image and the distance estimated from the RSSI obtained in Step S32 is within a predetermined range (S355). In the present exemplary embodiment, the item worn by user B appears in the surrounding image. Therefore, terminal 10A checks whether the distance between the distance estimated from the surrounding image and the distance estimated from the RSSI obtained in Step S32 is within the predetermined range. Note that when the item does not appear in the surrounding image in Step S353 (N in S353), whether another object appearing in the surrounding image corresponds to the item is verified (S354). When no other objects correspond to the item (N in S354), the RFID identification processes end. When another object corresponds to the item (Y in S354), the process in Step S354 is performed again.

When said difference is within the predetermined range in Step S355 (Y in S355), the processing proceeds to Step S36. Note that when said difference is not within the predetermined range in Step S355 (N in S355), the RFID identification processes end. When the difference between the distance between terminal 10A and the RFID tag that is indicated by the radio signal strength and the distance indicated in the distance information is not within the predetermined range in Step S355, terminal 10A displays the surrounding image without the product information being superimposed onto the surrounding image. At the same time, the RFID processes end.

The following description refers back to FIG. 15.

Next, when the RFID identification is successful in Step S35 (Y in S35), terminal 10A projects a product information pop-up in an object region of the surrounding image (S36). When the RFID identification is successful, the difference between the distance between terminal 10A and the RFID tag that is indicated by the radio signal strength and the distance indicated in the distance information is within the predetermined range. Therefore, terminal 10A superimposes the product information onto the surrounding image and displays the surrounding image on display 16. At the same time, terminal 10A establishes the short-range wireless communication with terminal 10B.

Next, terminal 10 checks whether the product information pop-up superimposed on the surrounding image has been clicked (S37).

When the product information pop-up has been clicked in Step S37 (Y in S37), the product information is advertised using the BLE (S38). In the present exemplary embodiment, terminal 10A requests the counterpart terminal, i.e., terminal 10B, to provide the item information of the item in the clicked product information. This is because the item corresponding to the clicked production information pop-up is an item that user A is interested in and the item information of which user A needs. Note that when the product information pop-up has not been clicked in Step S37 (N in S37), the present processing ends.

Next, terminal 10A checks whether the difference between the distance estimated from the surrounding image and the distance estimated using the RSSI obtained from terminal 10B is within a predetermined range (S39). Note that when said difference is not within the predetermined range in Step S39 (N in S39), the present processing ends (S40) because if the counterpart terminal transmits the item information, this transmission fails.

On the other hand, when said difference is within the predetermined range in Step S39 (Y in S39), terminal 10A receives a coupon issued by the counterpart terminal (S41). The coupon, which is one example of the item information, includes a parameter of an affiliate link in the present exemplary embodiment. The parameter of the affiliate link is one example of the above-described item positive-obtainment information. The affiliate link is one example of the URL of an online website that is managed by service server 30 and sells one or more items worn by user B, for example.

Next, when user A wishes to purchase the product using the coupon, user A causes terminal 10A to access the affiliate link (S42).

Subsequently, using the coupon, the user purchases the product that is the item (S43).

Note that the above-described exemplary embodiment describes the case where terminal 10A, terminal 10B, and service server 30 are not included in a blockchain network, but this is not limiting. Terminal 10A, terminal 10B, and service server 30 may be included in a blockchain network, or service server 30 alone may be included in a blockchain network.

As described above, with the control method, etc., according to the present exemplary embodiment, user A can establish the short-range wireless communication more easily via the passer-by communication, and moreover can select, by referring to an image and the like showing the product information, at least one of the physical items worn by user B.

Furthermore, with the control method, etc., according to the present exemplary embodiment, the RFID identification makes it possible to reduce malfunctions including a failure to obtain the item information of at least one item selected by user A due to a failure to properly obtain the item identifier of said item.

### Other Variations

Although the present disclosure has been thus far described based on the above exemplary embodiments, it goes without saying that the present disclosure is not limited to the above exemplary embodiments. The following cases are also included in the present disclosure.

The description in the above exemplary embodiments is based on the premise that the first terminal and the second terminal are carried by the first user and the second user, respectively, but this is not limiting.

For example, the second terminal may be a stationary terminal while the first terminal is carried by the first user. In this case, for example, a coupon may be transmitted from a stationary home terminal (the second terminal) installed in a private residence, and a smartphone (the first terminal) carried by a user who visits its neighborhood may receive the coupon.

Furthermore, for example, the first terminal may be a stationary terminal while the second terminal is carried by the second user. In this case, for example, a user who advertises items visits a private residence to provide a delivery service and transmits a coupon from a smartphone (the second terminal) carried by the user, and a stationary home terminal (the first terminal) installed in the private residence may receive the coupon.

Each of the devices according to the above exemplary embodiments is specifically a computer system configured of a microprocessor, read only memory (ROM), random access memory (RAM), a hard disk unit, a display unit, a keyboard, and a mouse, for example. A computer program is recorded on the RAM or the hard disk unit. Each of the devices achieves its function by way of the microprocessor operating according to the computer program. Here, the computer program is configured of a combination of command codes indicating instructions to the computer in order to achieve a predetermined function.

Some or all of the structural elements included in each of the devices according to the above exemplary embodiments may be configured from a single system Large Scale Integration (LSI). A system LSI is a super-multifunction LSI manufactured with a plurality of components integrated on a single chip, and is specifically a computer system configured of a microprocessor, ROM, and RAM, for example. A computer program is recorded on the RAM. The system LSI achieves its function by way of the microprocessor operating according to the computer program.

Furthermore, each unit of the structural elements included in each of the devices described above may be individually configured into a single chip, or some or all of the units may be configured into a single chip.

Moreover, although a system LSI is mentioned here, the integrated circuit can also be called an IC, a LSI, a super LSI, and an ultra LSI, depending on the level of integration. Furthermore, the method of circuit integration is not limited to LSIs, and implementation through a dedicated circuit or a general-purpose processor is also possible. A field programmable gate array (FPGA) which allows programming after LSI manufacturing or a reconfigurable processor which allows reconfiguration of the connections and settings of the circuit cells inside the LSI may also be used.

In addition, depending on the emergence of circuit integration technology that replaces LSI due to progress in semiconductor technology or other derivative technology, it is obvious that such technology may be used to integrate the function blocks. Possibilities in this regard include the application of biotechnology and the like.

Some or all of the structural elements included in each of the devices described above may be implemented as a standalone module or an IC card that can be inserted into and removed from the device. The IC card or the module is a computer system made up of a microprocessor, ROM, RAM, and so on. The IC card or the module may include the aforementioned super multifunctional LSI. The IC card or the module achieves its functions by way of the microprocessor operating according to the computer program. The IC card and the module may be tamperproof.

The present disclosure may be the above-described methods. Furthermore, the present disclosure may be a computer program for implementing these methods using a computer or may be a digital signal of the computer program.

Furthermore, the present disclosure may be a computer program or a digital signal recorded on a computer-readable recording medium, such as a flexible disk, a hard disk, a compact disc read-only memory (CD-ROM), a magneto-optical disc (MO), a digital versatile disc (DVD), DVD-ROM, DVD-RAM, a Blu-ray (registered trademark) disc (BD), or a semiconductor memory, for example, The present disclosure may also be the digital signal recorded on these recoding media.

Furthermore, in the present disclosure, the computer program or the digital signal may be transmitted via an electrical communication line, a wireless or wired communication line, a network represented by the Internet, data broadcasting, or the like.

Furthermore, the present disclosure may be a computer system including a microprocessor and memory. The memory may have the computer program recorded thereon, and the microprocessor may operate according to the computer program.

Moreover, by transferring the recording medium having the program or the digital signal recorded thereon or by transferring the program or the digital signal via the network or the like, the present disclosure may be implemented by a different independent computer system. The above exemplary embodiments and the above variations may be combined with each other.

### INDUSTRIAL APPLICABILITY

The present disclosure can be used for a control method, a recording medium, and a terminal; the present disclosure can be used for a control method, a recording medium, and a terminal that enable physical item advertising based on passer-by communication as advertising that is likely to lead to sales.

1. A method for controlling a first terminal carried by a first user and capable of communicating with a server via a network, the method comprising:
establishing short-range wireless communication by the first terminal with a second terminal carried by a second user;
requesting the second terminal by the first terminal via the short-range wireless communication to provide item information, or requesting the server by the first terminal via the network to provide the item information, the item information being information related to at least one item included in one or more items worn by the second user, the requesting being performed using identification information of the at least one item that has been obtained upon the establishment of the short-range wireless communication;
obtaining the item information by the first terminal; and
displaying the item information obtained.

2. The method according to claim 1, wherein
the obtaining of the item information includes:
obtaining the item information by the first terminal from the second terminal or the server.

3. The method according to claim 1, further comprising:
when the short-range wireless communication is established with the second terminal,
obtaining, by the first terminal, the identification information of the at least one item from a radio-frequency identification (RFID) tag attached to the at least one item.

4. The method according to claim 3, wherein
the establishing includes:
receiving a communication signal including identification information of the one or more items and information indicating a location of product information of the one or more items, the communication signal being predetermined and transmitted from a RFID tag attached to the one or more items;
obtaining a surrounding image of the first terminal from a camera included in the first terminal, the surrounding image including the second user;
establishing the short-range wireless communication with the second terminal when the one or more items are included in the surrounding image; and
displaying, by the first terminal, the surrounding image on a display included in the first terminal, with the product information of the one or more items being superimposed onto the surrounding image, the product information being obtained based on the information indicating the location.

5. The method according to claim 4, wherein
the receiving includes:
obtaining radio signal strength of an RFID tag attached to each of the one or more items,
the obtaining of the surrounding image includes:
obtaining distance information indicating a distance from the first terminal to each of the one or more items included in the surrounding image, and
in the displaying,
when a difference between a first distance indicated by the radio signal strength and a second distance is not within a predetermined range, the surrounding image is displayed without the product information being superimposed onto the surrounding image, the first distance being a distance between the first terminal and the RFID tag attached to one item included in the one or more items, the second distance being indicated in the distance information that corresponds to the one item.

6. The method according to claim 1, further comprising:
transmitting, to the server, item positive-obtainment information indicating that the item information has been obtained; and
obtaining, from the server, a coupon that is usable in an online store where an item indicated in the item positive-obtainment information is available for purchase.

7. The method according to claim 1, further comprising:
transmitting, to the server, item positive-obtainment information indicating that the item information has been obtained; and
when the item positive-obtainment information is transmitted to the server,
transmitting, to the second terminal, a coin issued by a seller of an item indicated in the item positive-obtainment information.

8. The method according to claim 7, wherein
the coin is issued when the item positive-obtainment information is recorded in the server.

9. The method according to claim 7, wherein
the server is included in a blockchain, and
the server issues the coin after the item positive-obtainment information is recorded in the blockchain.

10. The method according to claim 1, wherein
the server is included in a blockchain,
when the short-range wireless communication is established with the second terminal, the first terminal obtains a one-time password and identification information of each of the one or more items from the second terminal via the short-range wireless communication,
the requesting the server to provide the item information includes:
generating, by the first terminal, transaction data including the one-time password and the identification information of the at least one item; and
transmitting the transaction data from the first terminal to the server to cause the transaction data to be recorded in the blockchain, and
the obtaining of the item information includes:
when a password recorded in the blockchain and the one-time password match each other, obtaining, by the first terminal, the item information transmitted from the server.

11. The method according to claim 1, wherein
the server is included in a blockchain,
when the short-range wireless communication is established with the second terminal, the first terminal obtains a public key and identification information of each of the one or more items from the second terminal via the short-range wireless communication,
the requesting the server to provide the item information includes:
generating, by the first terminal, transaction data including the public key and the identification information of the at least one item; and
transmitting the transaction data from the first terminal to the server to cause the transaction data to be recorded in the blockchain, and
the obtaining of the item information includes:
when a public key recorded in the blockchain and a private key held by the second terminal match each other, obtaining, by the first terminal, the item information transmitted from the server.

12. A non-transitory computer-readable recording medium having stored therein a program for causing a computer to execute a method for controlling a first terminal carried by a first user and capable of communicating with a server via a network, the program causing the computer to execute:
establishing short-range wireless communication by the first terminal with a second terminal carried by a second user;
requesting the second terminal by the first terminal via the short-range wireless communication to provide item information, or requesting the server by the first terminal via the network to provide the item information, the item information being information related to at least one item included in one or more items worn by the second user, the requesting being performed using identification information of the at least one item that has been obtained upon the establishment of the short-range wireless communication;
obtaining the item information by the first terminal; and
displaying the item information obtained.

13. A terminal carried by a first user and capable of communicating with a server via a network, the terminal comprising:
a processor; and
memory, wherein
using the memory, the processor executes:
establishing short-range wireless communication with a terminal carried by a second user;
requesting the terminal carried by the second user via the short-range wireless communication to provide item information, or requesting the server via the network to provide the item information, the item information being information related to at least one item included in one or more items worn by the second user, the requesting being performed using identification information of the at least one item that has been obtained upon the establishment of the short-range wireless communication;
obtaining the item information; and
displaying the item information obtained.
